(19) United States
(12) Patent Application Publication
(10) Pub. No.: US 2012/0252577 A1
(43) Pub. Date: Oct. 4, 2012

(54) PORTABLE ELECTRONIC DEVICE

(76) Inventor: David Webster, Leppington NSW (AU)

(21) Appl. No.: 13/508,340

(22) PCT Filed: Oct. 27, 2010
(86) PCT No.: PCT/AU10/01424

§ 371 Date: Jun. 18, 2012

(30) Foreign Application Priority Data
Nov. 6, 2009 (AU) 2009905413

(51) Int. Cl. A63F 13/00

(52) U.S. Cl. 463/31

(57) ABSTRACT

A portable electronic device including: a memory for storing information including gaming information and location information; a display for displaying at least a portion of the information stored on the memory; a first data interface for communicating with a storage server and for transmitting gaming information to and receiving gaming information from the storage server; a second data interface for communicating with at least one other adjacent portable electronic device and for transmitting location information to and receiving location information from the at least one other portable electronic device wherein the information displayed on the display is dependent at least in part on the location information.

### FIELD OF THE INVENTION

The present invention relates to portable electronic devices and in particular to systems and methods for providing games to players playing the portable electronic devices and will be described with reference to this application. However, it will be appreciated that the invention is not limited to this particular field of use.

### BACKGROUND OF THE INVENTION

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

Card games are an extremely common pastime and they have increased in popularity over the years as new and increasingly more complex games are invented. Classic card games such as solitaire, poker, black jack and the like are played throughout the world by millions of players on a regular basis. More modern collectible card games, such as Magic: The Gathering is played by an estimated six million people in seventy countries.

Classic card games are generally played with one or more standard decks of playing cards, each card having a front or face that is marked with distinguishing indicia so as to differentiate it from other cards in the deck. A typical deck of cards includes 52 cards being divided into four suites of spades, hearts, diamonds and clubs. Each suite has 13 cards each marked with one of the following indicia: ace, two, three, four, five, six, seven, eight, nine, ten, jack, queen and king.

Modern collectible cards and card games are generally not limited to a specific number of distinguishing indicia and decks can include tens or even hundreds of cards each representing different characters, abilities, spells and the like. As the number of different cards increases so does the complexity of the game. This requires players to carry around increasingly large numbers of cards and remember many different rules which can both be difficult.

Other games such as board games including Scrabble, Cluedo, Monopoly and the like also have a number of static pieces and tokens. These pieces and tokens represent a single character, object or device which cannot typically be varied. A similar problem is faced by games such as miniature character games such as Warhammer that include a plurality of static characters and objects. Other such games include Ancient Miniatures, Diplomacy, Lord of the Rings and the like.

### SUMMARY OF THE INVENTION

The preferred embodiment of the present invention overcomes or ameliorates at least one of the disadvantages of the prior art, or at least provides a useful alternative.

According to a first aspect of the invention there is provided a portable electronic device including:

a memory for storing information including gaming information and location information;
a display for displaying at least a portion of the information stored on the memory;
a first data interface for communicating with a storage server and for transmitting gaming information to and receiving gaming information from the storage server;
a second data interface for communicating with at least one other adjacent portable electronic device and for transmitting location information to and receiving location information from the at least one other portable electronic device wherein the information displayed on the display is dependent at least in part on the location information.

Preferably there are a plurality of second data interfaces for communicating with a plurality of adjacent portable devices.

Preferably the portable device includes a user interface for allowing a user to control the device.

Preferably the user interface is a touch screen display. In some embodiments the user interface includes a keyboard. In some embodiments the user interface includes one or more physical or electronic software buttons.

Preferably the storage server is remote to the portable electronic device. Preferably the storage server communicates with a plurality of portable electronic devices.

Preferably the first data interface is a wireless communications interface. In other embodiments the first data interface is a wired communications interface. Preferably the first data interface is one of WIFI, USB, Ethernet, Microwave link, Bluetooth, infrared or the like.

Preferably the second data interface is a wireless communications interface. Preferably the wireless communications interface is a proximity interface. In other embodiments the second data interface is a wired communications interface. Preferably the second data interface is one of WIFI, USB, Ethernet, Microwave link, Bluetooth, infrared or the like.

Preferably each portable electronic device includes a magnetic coupling system to magnetically attach to an adjacent portable electronic device. Preferably each portable electronic device includes a plurality of magnetic coupling systems to simultaneously attach to a plurality of adjacent portable electronic devices.

Preferably the portable electronic device includes a plurality of edges wherein each edge includes a magnetic coupling system and a second data interface. Preferably the portable electronic device includes four edges wherein each edge includes a magnetic coupling system.

Preferably each magnetic coupling system includes a plurality of opposing magnetic poles that are magnetically attracted to complementary magnetic poles on an adjacent portable electronic device thereby coupling the devices together.

In other embodiments each portable electronic devices includes a mechanical coupling to couple with at least one of other portable electronic device.

Preferably the portable electronic device includes a sensor to determine whether the device is face up or face down. More preferably the sensor can detect whether the device is held or placed on a surface horizontally or vertically.

Preferably the devices can be selectively decoupled by the user. Preferably the devices are decoupling by a user exerting opposing forces on each device.

Preferably each user has a plurality of portable electronic devices which are used to play a game against one other user. Preferably the game includes the gaming information. In some embodiments a user has a plurality of portable electronic devices and plays a single person game.

Preferably at least a portion of the gaming information is downloaded from the storage server to the plurality of devices at the commencement of each game. Preferably gaming information is updated on each portable electronic device and on the storage server during the course of the game.

Preferably the gaming information includes game rules. Preferably the gaming information includes graphics and text for display on the display of each portable electronic device. Preferably each portable electronic device is allocated a character in the game and the gaming information displayed on each respective portable electronic device relates to the allocated character. Preferably the game includes association information and at least a plurality of characters in the game are associated such that when the association is activated when the portable electronic devices allocated to those associated characters are placed adjacent one another. Preferably the association information is transmitted through the second data interface. Preferably when activated, the association provides the associated characters with additional abilities in the game that are not available when the association is not activated. In some embodiments, when activated the association provides the associated characters with reduced abilities in the game that are not present when the association in not activated.

According to a second aspect of the invention there is provided a method of providing a portable electronic device including:

providing a memory for storing information including gaming information and location information;
providing a display for displaying at least a portion of the information stored on the memory;
providing a first data interface for communicating with a storage server and for transmitting gaming information to and receiving gaming information from the storage server;
providing a second data interface for communicating with at least one other adjacent portable electronic device and for transmitting location information to and receiving location information from the at least one other portable electronic device wherein the information displayed on the display is dependent at least in part on the location information.

According to a third aspect of the invention there is disclosed a system for providing a game to a user including:

a storage server for storing information relating to the game;
a plurality of portable electronic devices each having:
a first data interface for communicating with the storage server and receiving from the storage sever at least a portion of the information relating to the game;
a display for displaying the at least a portion of the information relating to the game;
a second data interface for communicating with at least one other adjacent portable electronic device and for transmitting location information to and receiving location information from the at least one other portable electronic device wherein the at least a portion of the information displayed on the display is dependent at least in part on the location information.

Preferably the game is provided to a plurality of players wherein at least one portable electronic device is allocated to each player of the game. More preferably a plurality of portable electronic devices are allocated to each player of the game.

Preferably the storage server stores game rules and the game rules are transmitted to the plurality of portable devices.

Preferably the storage server is in constant communication with the plurality of portable electronic devices so as to control the rules of the game.

Preferably the portable electronic devices transmit the location information to the storage server so as to control the rules of the game.

Preferably the storage server transmits an activation signal to at least one portable electronic device in response to the location information.

Preferably the activation signal causes the at least one portable electronic device to display additional information on the display thereby activating a feature of the game.

Throughout the specification and claims which follow, unless the context requires otherwise, the word “comprise”, and other variations such as “comprises” and “comprising”, will be understood to imply the inclusion of a stated integer or step or group of integers or steps but not the exclusion of any other integer or step or group of integers of steps.

### BRIEF DESCRIPTION OF THE DRAWINGS

A preferred embodiment of the invention will now be described, by way of example only, with reference to the accompanying drawings in which:

FIG. 1 is a system according to the invention;

FIG. 1a is a portable electronic device according to the invention;

FIG. 1b is a storage server according to the invention;

FIG. 1c is a device holding rack and individual device stands shown holding devices according to the invention;

FIG. 2a is a diagram of an existing device already in play and a newly deployed device according to the invention;

FIG. 2b shows attached devices according to the invention;

FIG. 2c shows stacked devices according to the invention;

FIG. 3a shows an example of enhancements available to attached devices according to the invention;

FIG. 3b shows a further example of enhancements available to attached devices according to the invention;

FIG. 3c shows a plurality of attached devices according to the invention;

FIG. 3d shows an example of a game in progress between four players according to the invention;

FIG. 3e shows an example of a game in progress between two players according to the invention;

FIG. 3f shows an example of a classic card game between two players according to the invention.

### PREFERRED EMBODIMENT OF THE INVENTION

The preferred embodiment of the invention provides a plurality of portable electronic devices, each having a screen on which a combination of text information and/or graphics is displayed. Each device includes functionality to transfer information to it from an information storage device (such as a computer server, the internet, another portable electronic device). This functionality can be provided by WIFI, USB cable, Ethernet cable, infrared, Bluetooth, microwave link or the like. Alternatively the device includes memory such as an SD card or micro SD card to which information can be written. The screen is an LCD screen and the device includes a key pad which can be included as a touch screen LCD or as separate buttons. The information on each device can be updated by a user as required thereby changing information that is displayed on the device.

A plurality of the portable devices are used in a preferred system of the invention wherein each device displays different information (in the form of text, image or a combination thereof) and that information is used to play a game. In one form the system could include 52 devices with each device displaying an image representing one card from a traditional deck of card (that is, one device each for cards Ace to King and each suite spades, diamonds, clubs, hearts). The devices are then used to play a card game in the normal manner. In other forms the games are more complex however each device acts as a separate piece or card by displaying a different graphic (which is not necessarily unique to the game in cases where games allow more than one of the same card). In its simplest form the system could include only 2 devices which are used to play a game according to the game rules. Using proximity and orientation sensors in each device allows the devices to determine their orientation and proximity to the other device or devices. This proximity and orientation may cause additional features or functions to be displayed on the device.

Each portable device includes means to allow communication between the plurality of devices. This communication is preferably provided by means of a WIFI connection and/or proximity communication device which allows communication between devices. Using a proximity and/or orientation functionality allows each device to change the display that it displays when it is placed next to a device displaying related information (the change of the display would be according to predetermine game rules). For example, two related devices that when placed next to each other may activate an additional feature that is then displayed on each device (or possibly over the device by using the displays of each device to create a single larger display).

In the preferred embodiment the devices can be updated by using a personal computer that wirelessly transmits information to the devices. The devices can include an SD card or other memory card than can store a plurality of game rules and gaming information (including graphics) to allow a user to easily switch the games that they play. In one example the user may play a traditional card game but then switch to a different game such as dominos (where each device displays a different domino), or any other suitable card game such as Magic: The Gathering or the like where the device would display a character card. Devices can be any suitable game piece such as trading cards, miniatures, units, tokens and the like. In the preferred embodiment devices can be joined or magnetically coupled together at various orientations. The devices can detect which orientation they are coupled in and can display different displays according to predetermined game rules. Typical games according to the invention are those that are turn based but any suitable card based game can be played using devices according to the invention. In some embodiments the games played are real time games, that is games that are not turned based. These may includes real time adventure games such as Warcraft and Diablo, first person character games such as Doom and Halo and the like. In the preferred embodiment new games can be downloaded to the devices from the Internet or purchased on CD ROM and downloaded onto the devices using a personal computer.

The invention allows the devices to communicate with one another and change the information displayed on each device according to predetermine game rules. The devices have proximity and/or orientation sensors therein which allow them to detect when they are placed close to or next to another device. Information can then be exchanged between the devices and the information and/or graphic displayed on each device can change according to the information exchanged. In one example, if two of the devices displaying the same information are placed next to one another during a game this may trigger an event which is displayed on the displays of the two devices next to each other. The preferred embodiment of the invention allows the devices to communicate with one another and update the information thereon according to their placement in the game.

As would be understood, communications between portable devices and/or the master controller(s) can be either peer-to-peer (P2P) or by access point. Typically if a master Controller is not used a peer-to-peer system is used. If a master controller is used then communication would typically be by access point. However it would be understood that a combination of peer-to-peer and access point communication can be used if appropriate in some games.

Each portable electronic device also includes an orientations sensor to detect whether the device is face up or face down. The face up or face down status is transmitted to the storage server and/or to other portable electronic devices as may be required by the game being played. The orientation sensor can also determine whether the device is being held or placed vertically or horizontally. Suitable sensors can include a hall effect sensor.

Typically, when a device is placed faced down this indicates that the device is out of play and when it is face up this indicates the device is in play. As discussed above this status can be communicated to the storage server and/or other portable electronic devices.

Accordingly, the preferred embodiment of the invention provides a portable electronic device that includes a memory for storing information including gaming information and location information. The memory can be in any suitable form such as a hard drive, or portable memory stick (SD card, Micro SD card, USB key and the like). The device includes a display for displaying at least a portion of the information stored on the memory. A first data interface communicates with a storage server and for transmits gaming information to and receives gaming information from the storage server. A second data interface communicates with at least one other adjacent portable electronic device for transmitting location information to and receiving location information from the at least one other portable electronic device wherein the information displayed on the display is dependent at least in part on the location information.

A system according to the preferred embodiment of the invention includes a plurality of second data interfaces for communicating with a plurality of adjacent portable devices.

The portable device includes a user interface in the form of a touch screen display and/or a keyboard for allowing a user to control the device. The keyboard can be a software keyboard that is displayed on the touch screen display or may be a physical keyboard with keys below or next to the display.

The storage server that downloads information to the portable electronic device is normally remote to the devices and communicates with a plurality of portable electronic devices. The storage server, otherwise called the gaming server, controls the game by communicating with each device active in the game.

In this specification, the terms storage server, master controller and game controller are used interchangeably and the use may reflect the primary function of the device at any point. It would be understood that the term generally refers to an electronic device that is able to execute instructions, store information, communicate with other devices and generally act as programmed according to any software that may be executed on the device. The device may be a portable electronic device as described herein, a personal computer, a laptop, a note book, a netbook, a smart phone such as an Iphone and the like.

The first data interface is a wireless communications interface preferably one of WI-FI, USB, Ethernet, Microwave link, Bluetooth or the like. In other embodiments the first data interface is a wired communications interface but wireless communication is preferred.

The second data interface is a wireless communications interface which in this instance is a proximity interface such as Bluetooth. In other embodiments the second data interface is a wired communications interface. In other embodiments wireless communication interfaces such as WI-FI, USB, Ethernet, Microwave link, Bluetooth or the like can be used. In one embodiment the first data interface and the second data interface are a single communications device defining two virtual communication paths.

Each portable electronic device includes a magnetic coupling system to magnetically attach to an adjacent portable electronic device. In the preferred embodiment each portable electronic device is rectangular shapes and includes four edges or sides each side having a plurality of magnetic coupling systems to simultaneously attach to a plurality of adjacent portable electronic devices. Each magnetic coupling system also includes a second data interface so that adjacent devices are securely magnetically coupled together which also provides a good communications channel between the respective second data interfaces on each device.

It would be understood that the shape of the portable electronic devices can be varied to any suitable shape however it is preferred that each edge or side includes a magnetic coupling system and a second data interface.

Each magnetic coupling system includes a plurality of opposing magnetic poles that are magnetically attracted to complementary magnetic poles on an adjacent portable electronic device thereby coupling the devices together. The devices can be selectively decoupled by the user by exerting opposing forces on each device.

It would be understood that each player can be allocated one or more portable electronic devices for use during the game. In the preferred embodiment each user has a plurality of portable electronic devices which are used to play a game, that includes the gaming information, against one or more other users. It would also be understood that the plurality of devices can be used by a single player to play a single player game and accordingly, there is no requirement for a second player.

At the commencement of each game at least a portion of the gaming information is downloaded from the storage server to the plurality of devices. The gaming information downloaded to each device typically includes the game rules and other information as described below.

During the course of the game, gaming information is updated on each portable electronic device and on the storage server using the chosen communications interface.

The gaming information downloaded to each device includes game rules, graphics and text for display on the display of each portable electronic device. Each portable electronic device is also allocated a character or object in the game and the gaming information displayed and downloaded on each respective portable electronic device relates to the allocated character. The game also includes association information and at least a plurality of characters or objects in the game are associated such that when the association is activated when the portable electronic devices allocated to those associated characters are placed adjacent one another. The association information is transmitted between the devices through the second data interface. When activated, the association provides the associated characters with additional abilities in the game that are not available when the association is not activated. Characters could include humanoid characters, animals, cars, planes, spaceships and the like. Objects could include walls, water, weapons, trees, bridges, spells, potions, enchantments, traps and the like.

Embodiments of the invention are also directed to a method of providing a portable electronic device including providing a memory for storing information including gaming information and location information. The method also provides a display for displaying at least a portion of the information stored on the memory and a first data interface for communicating with a storage server and for transmitting gaming information to and receiving gaming information from the storage server. The method further provides a second data interface for communicating with at least one other adjacent portable electronic device and for transmitting location information to and receiving location information from the at least one other portable electronic device wherein the information displayed on the display is dependent at least in part on the location information.

Additional embodiments of the invention are directed to systems for providing a game to a plurality of user. The systems include a storage server for storing information relating to the game and a plurality of portable electronic devices. Each portable electronic device has a first data interface for communicating with the storage server and receiving from the storage sever at least a portion of the information relating to the game. Each device also includes a display for displaying the at least a portion of the information relating to the game. Each device also includes a second data interface for communicating with at one other adjacent portable electronic device and for transmitting location information to and receiving location information from the at least one other portable electronic device wherein the at least a portion of the information displayed on the display is dependent at least in part on the location information. In the preferred embodiment the game is provided to a plurality of players wherein at least one portable electronic device is allocated to each player of the game. Any number of devices can be allocated to each player for use in the game. In some games 40-100 devices are allocated to each player. In some embodiments even devices are used more with the limit being determined by the rules of each particular game. As would be understood the storage server stores game rules and the game rules are transmitted to the plurality of portable devices. It is preferred that the storage server is in constant communication with the plurality of portable electronic devices so as to control the rules of the game. During the course of the game the portable electronic devices transmit the location information to the storage server so as to control the rules of the game. During the game the storage server transmits an activation signal to at least one portable electronic device in response to the location information. The activation signal causes the at least one portable electronic device to display additional information on the display thereby activating a feature of the game.

A preferred embodiment of the invention will now be described with reference to the drawings. A gaming platform system is described in which each player utilises multiple portable handheld electronic devices each of which includes a display component, user input component, communications component and proximity/positioning components.

The devices are CPU driven and typically use Wi-Fi for gaming data communications and interactive game play, an LCD display with either touch screen capability or separate button controls for additional interactive game play, and optionally device coupling mechanisms to allow the devices to be joined or magnetically coupled at various orientations to take advantage of new game play options and device interactions.

The software platform allows an infinite variety of games to be played which are downloaded and installed on either the multiple devices themselves, a master ‘device’ or storage server, a nearby PC, laptop computer or other hand-held device. Typically, game play proceeds in turns or real-time with each player placing their set of devices on the game play area in various configurations and times based upon the rules for the particular game, moving or re-orienting their devices at appropriate times, and interactively controlling their devices using touch screens or buttons before and/or during game play.

The gaming platform is a generic platform which can be programmed to play entirely new games, or traditional games wherein the devices may be programmed to represent traditional game “pieces” such as trading cards, miniatures, units, tokens, or any other game piece.

In its simplest form the system requires players to use at least two devices, although most games will require a larger number such as 10, 20, 40, 52 or 60+ devices, depending on the complexity and nature of the game. Use of multiple devices by each player also allows the possibility of interaction between the devices not possible with other prior art gaming platforms. Interaction between the devices may take a variety of forms including but not limited to, devices being attached (physically adjacent) to other device(s), devices being turned to an angle of 90, 180, or 270 degrees, devices being stacked on top of or below other devices, and the devices being flipped face-up or face down.

Some advantages of this gaming platform system are as follows:

1. Use of multiple handheld electronic devices instead of the traditional single device. Multiple electronic devices are used by each player (i.e. at least two, but normally many more such as 10, 20, 40, 60+). This allows for enhanced and additional game play options not available with other game platforms which only use a single electronic device.
2. New control mechanisms are provided for players. Players control the physical positioning and orientation of the electronic devices. Physical device positions, orientations and interactions data are available for processing by the game software. These include whether the devices are face-up or face-down, adjacent to other devices (and which other devices), orientation (typically 0, 90, 180 or 270 degrees), and whether stacked on top of other device(s).
3. A new game genre is created through new, innovative game play options. The physical interactions of the devices described above provide players with a brand new set of user inputs, which, when combined with more traditional user inputs such as device buttons and on-screen controls, produces a brand new genre of games and game software which has not been seen before. This will enhance the enjoyment of game players through new combinations of innovative game play options.

The gaming platform system allows game developers and publishers to devise and produce their own games for release on the platform. An advantage of the platform of the preferred embodiment is that games developers have many new inputs from the user interfaces in the form of device positions, orientations, facings and associated interactions available to them many. This platform therefore introduces innovation into the gaming market which developers and gamers alike will find new and enjoyable.

In some embodiments the portable electronic devices include a wireless power system which allows all devices to be powered/recharged and for the game to be played on the same wireless power board. The wireless power board could serve a dual role in detecting precisely where each device is located, thus obviating the need for the magnetic/mechanical coupling system and second communications interface or system, In this embodiment the second interface could be removed form the devices such that no proximity interface is required. As such, the wireless power board detects where each device is located and transmits this to the master controller. This embodiment may be preferred in cases where charging of the individual portable electronic devices becomes difficult due to the number of devices required to be charged.

As would be understood by those skilled in the art, wireless energy transfer or wireless power transmission in which electrical energy is transmitted from a power source to an electrical load, without interconnecting wires. The most common form of wireless power is carried out using induction, followed by electrodynamic induction. Other technologies for wireless power include those based upon microwaves and lasers however portable electronic devices according to the preferred embodiment of the invention can use any suitable form of wireless power.

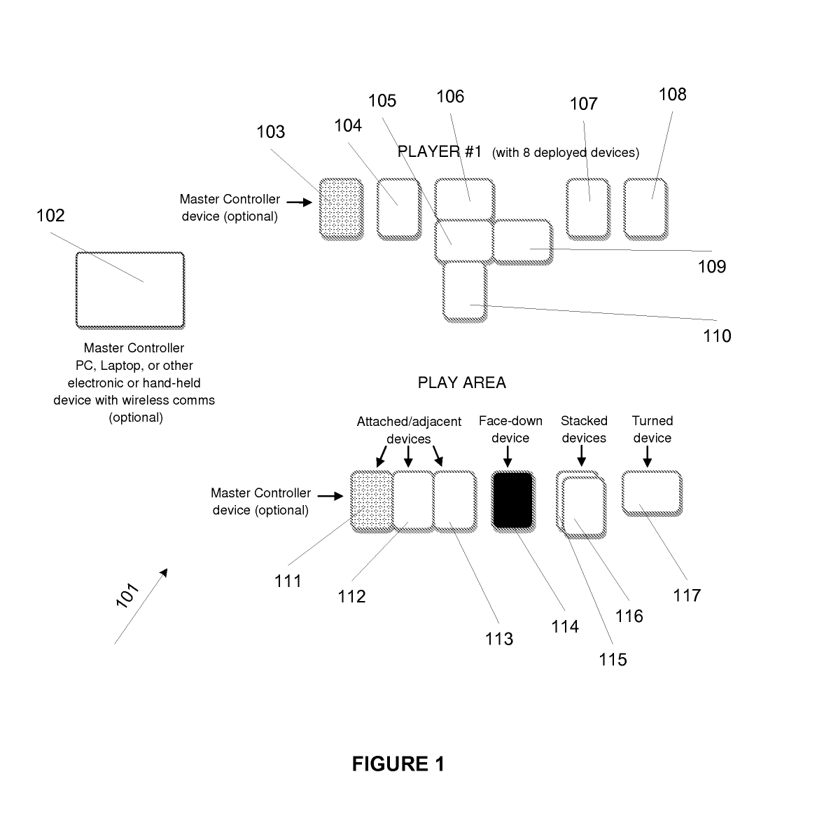

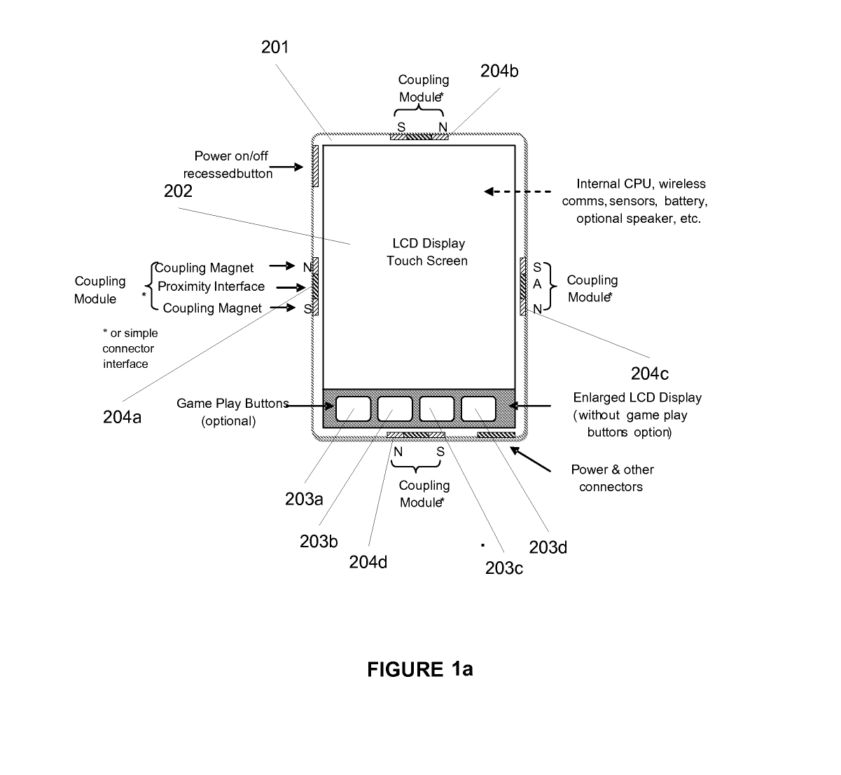

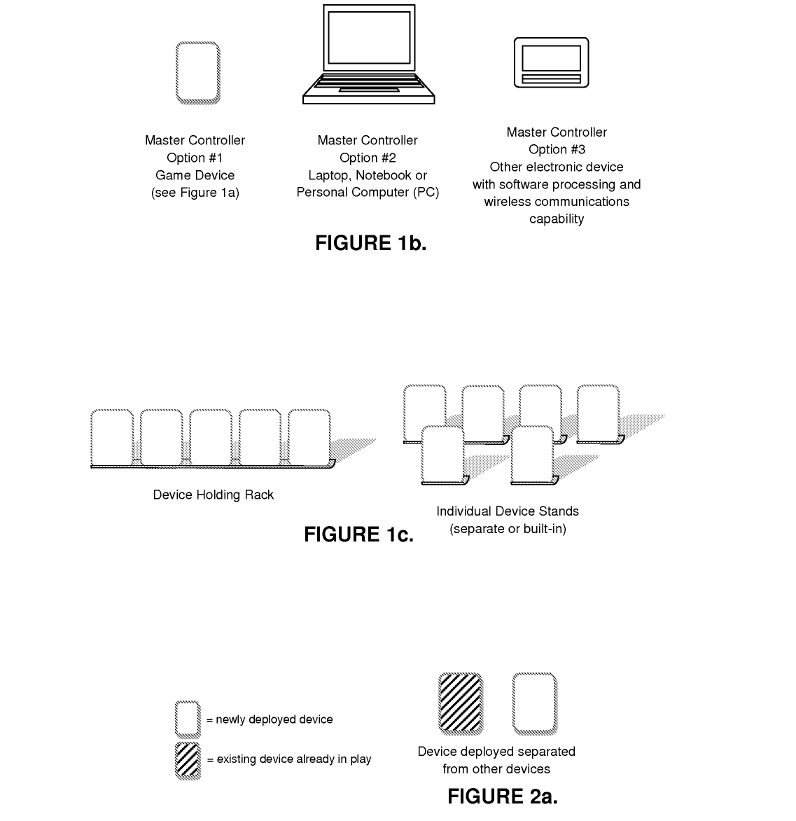

Referring now to FIG. 1, there is shown a typical system 101 according to the invention. In this example there are two players, and that they have already deployed some of their devices.

The system includes a plurality of portable electronic handheld devices for each player. Player 1 has 8 devices deployed that are active in the game, these being devices 103, 104, 105, 106, 107, 108, 109 and 110. Player 2 has 7 deployed devices that are active in the game. These are devices 111, 112, 113, 114, 115, 116 and 117.

Each portable electronic device is a playing “pieces” active in the game, and may represent units, miniatures, tokens, cards, characters, ships, weapons, spells, abilities, or any other conceivable object or item as programmed into the software.

The storage server or master controller is in communication with the portable electronic devices. The state of play as can be seen in FIG. 1 is as follows. Devices 103 and 111 can optionally be designated as master controllers. It would be understood that each game could include a plurality of master controllers according to the requirements of each game and the number of devices required to be in communication with the master controllers. In some preferred embodiments three master controllers are used. Devices 104, 105, 106, 107, 108, 109, 110, 112, 113, 115, 116 and 117 are designated as regular devices in this game, however, it would be understood that any one or more of those devices could be designated as a master controller. Devices 105, 106, 109 and 110 are coupled together which may activate a feature not otherwise available to player 1. Device 114 is face down which may indicate the device is temporarily unavailable for use by player 2. Devices 115 and 116 are stacked which may activate a feature not otherwise available to player 2. As can be seen, devices 117, 105, 106 and 109 are turned which may indicate use of a feature associated with those devices. As would be understood the display on each of the devices changes to indicate the status of the device according to the game rules. The status of each device is preferably communicated to the master controller.

In one embodiment one of the devices, such as device 111 acts as the master controller alleviating the need to use an additional computer 102.

Referring to FIG. 1a, each portable electronic device 201 includes some or all of the following components:

a. A display, in this embodiment a touch screen colour LCD display 202;
b. A CPU to provide processing power to drive device functions and optionally to execute game software;
c. A communications component, for example Wi-Fi networking, Bluetooth or infrared, or any other communications system in order to communicate with the ‘Master Controller’ and/or other devices;
d. Button(s) 203 a-d to turn the device on/off and/or to provide players with user inputs as part of the game being played;
e. Sensor(s) to detect whether the device is in a face-up or face-down position;
f. Coupling mechanisms to be able to place devices adjacent to one another, for example magnets that will allow devices to remain adjacent, in contact with one another on the play area, or alternatively mechanical connectors or any other form of coupling mechanism. Coupling mechanisms may be optional if proximity sensors are used which detect close proximity of devices;
g. Sensors to detect when the device is adjacent to/touching other device(s), and means to detect which other device(s) are adjacent/touching;
h. Proximity components to detect relative and/or absolute positions of devices in the play area;
i. A power source, for example built-in batteries, wireless power, or any other means of powering the electronic device;
j. Speaker(s) and/or microphone; and
k. Connector(s) as required for power connections and/or alternate communications systems.

In this embodiment the portable electronic device includes four coupling modules 204 a-d for coupling up to four other portable electronic devices. Each coupling module includes a proximity interface for communicating with another device. The proximity interface allows information to be transferred to and from coupled devices. Each module also includes a North and South pole magnetic pair which is complementary and engages with another device so as to keep the devices securely coupled until separated by a player.

A master controller or storage server will now be described with reference to FIG. 1b. The Master Controller can be either a dedicated handheld electronic device similar or identical to the multiple devices described in 1 above, or alternatively a separate computing device such as a PC, laptop computer, or other electronic device (iPhone, smartphones and the like). The Master Controller must have means to execute the game software, and be able to communicate with and control the multiple devices, for example using Wi-Fi or any other communications format/protocol. The Master Controller receives a variety of inputs from each device including, but not limited to, whether the device is face-up or face-down, whether adjacent to other devices (and which ones), the orientation (typically whether turned by 0, 90, 180 or 270 degrees), whether stacked on top of other device(s), and all player input from buttons and touch screen controls. It processes this information to determine what is displayed on each device, and what on-screen controls are available on each device, depending on the game rules as programmed into the game software.

Prior to the commencement of a game, the master controller can be used to initialise each portable electronic device. During this process each device is identified to the master controller and the relevant gaming information is downloaded to the device. Each device may also be allocated unique character information if required. This can be done using player input or automatically by the master controller.

Referring now to FIG. 1c, some games may make use of a dedicated device ‘Holding Rack’ or multiple ‘Device Stands’, which will allow multiple devices to be placed at a near vertical orientation so as to be visible to the owning player, but not to any opponent(s). Individual device stands may be built-in to the devices so as to flip outwards to form the stand, when required.

During game play, players will physically position their devices in order to attempt to achieve the win conditions of the particular game being played. Positioning includes, but is not limited to, deployment, movement, and removal. These are described below.

### A. Physical Device Positioning

### A.1. Deployment

Deployment is the act of placing a device onto the play area so as to benefit the player in achieving the win conditions for the particular game being played. The ways a device can be deployed includes, but is not limited to, the following:

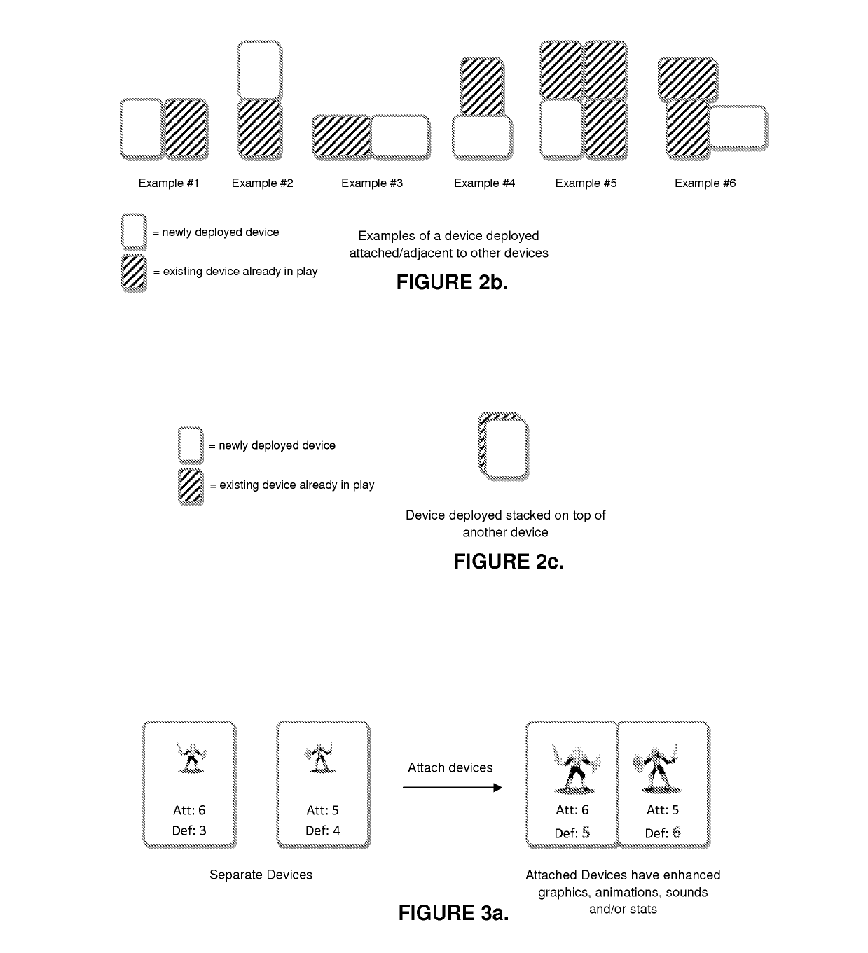

A.1.1. A device may be placed on the play area separated from all other devices as shown in FIG. 2a.
A.1.2. A device may be placed on the play area attached (directly adjacent) to another device, either to the left, right, in front of, or behind the other device as shown in the examples in FIG. 2b.
A.1.3. A device may be placed on the play area directly on top of another device, in effect covering up the other device. The devices become stacked as shown in FIG. 2c.
A.1.4. Any of the above, but turned so as to be oriented at 90, 180 or 270 degrees from the normal orientation.

### A.2. Moving/Re-Positioning

A device that has already been deployed and is therefore already in the play area may be moved (re-positioned), depending on the game rules of the game being played. Generally, movement of a device is similar or identical to the method of deployment as described above, except that a device is removed from one part of the play area and placed somewhere else on the play area. The ways a device may be re-positioned includes, but is not limited to, the following as shown in FIGS. 2a, 2b and 2c.

A.2.1. Attaching a device to another device or devices so that it is adjacent.
A.2.2. Detaching a device from another device or devices so that it is separated.
A.2.3. Turning the device by 90, 180 or 270 degrees.
A.2.4. Putting the device on top of another device, thereby stacking one device on top of another device.
A.2.5. Moving the device off another device, thereby unstacking the device.
A.2.6. Turning the device over to be face-up or face-down.
A.2.7. Any combination of the above

### A.3. Removal

A device that has already been deployed and is therefore already in the play area may be removed from the play area, depending on the game rules of the game being played. The ways a device may be removed depends upon the game rules and includes, but is not limited to, the following:

A.3.1. Removing a device from the play area to a ‘discard’ area.
A.3.2. Removing a device from the play area to a player's Holding Rack, or individual Device Stands.
A.3.3. Removing a device from the play area to a player's hand.
A.3.4. Removing a device from the play area to a player's device deck.
A.3.5. In general, removing a device from the play area to any region outside the play area
A.3.6. Any of the above, with the removed device being oriented face-up, face-down, or vertically if placed in a device rack or hand

### B. Device Interface Functionality

A player will use the touch screen controls (and/or buttons) on his/her devices in order to control game actions to attempt to achieve the win conditions of the particular game being played. It is expected that most devices and the game software which runs on them will rely mainly upon a touch-screen interface for interaction with players, however the following also applies to any physical buttons on the devices.

Interactive functionality of the devices includes, but is not limited to, the following.

B.1. Pressing (touching) an on-screen button, thereby activating, deactivating or controlling a game action.
B.2. In general, pressing (touching) any icon, level indicator, selector, picture, graphic, screen area, or any portion of the display which has been enabled by the game software to allow a player to press (touch) and thereby activate, deactivate or control a game action.
B.3. As above, but holding down (touching) for a period of time which, depending on the game software/rules, may have an alternative affect compared to a momentary press (touch).
B.4. As above, but pressing (touching) rapidly multiple times which, depending on the game software/rules, may have an alternative affect compared to a momentary press (touch).
B.5. Sliding a finger across the on-screen display for the purpose of moving or controlling an aspect of game play. For example this may be to move a graphic/icon on the device display, to slide an on-screen slider control up, down, left or right, or to otherwise change a game action as provided by the game software/rules.
B.6. Zooming in or out through the use of multi-touch screen control which, depending on the game software/rules, will enable, disable, change, or control particular game actions.

### C. Game Software

Each game will provide its own game software to control all devices. The software will be pre-loaded onto the game platform Master Controller and/or devices before, the game begins, and also during the game if required. Each game will have its own set of rules which are programmed into the software. The software will control what is displayed on all devices in the game. Typically, the software sends a graphical output to each display, or sends control signals to each device telling it what to display, consisting of graphics (pictures/images), animated pictures or video/movies, and on-screen controls such as buttons, icons, sliders and other controls which can be operated by the players.

The software is able to detect a wide variety of inputs from each device, including but not limited to, the following.

C.1. Device is face-up or face-down,
C.2. Device is attached (adjacent to) another device,
C.3. Which other device(s) a device is attached (adjacent) to,
C.4. If attached, what orientation the device is, normally 0, 90, 180 or 270 degrees,
C.5. Whether the device is on top of or below another device,
C.6. Which other device the device is on top of, or below,
C.7. All device touch screen buttons (and/or regular buttons),
C.8. All other device on-screen controls (and regular controls), including sliding controls, multi-touch controls, zoom controls, etc.

The software will process all inputs from all devices, and output control signals or graphics, animated graphics, buttons, icons, sliders, controls, and any other game output to all devices depending on the particular game being played.

It is not necessary that all inputs (C.1 to C.8 above) are used by all games. Most games will reply upon some of the inputs and ignore others. Generally speaking the more complex games will process and act upon more inputs. The simplest games will likely only use one input, for example whether the device is face-up (in play) or not.

### D. Device Interactions

The use of multiple devices introduces a new set of game interactions not available in prior art gaming systems. The new device positioning inputs available to players, in combination with touch screen or button controls, allows the gaming software to display interactions between the devices.

The ways a device can interact and display these interactions includes, but is not limited to, the following:

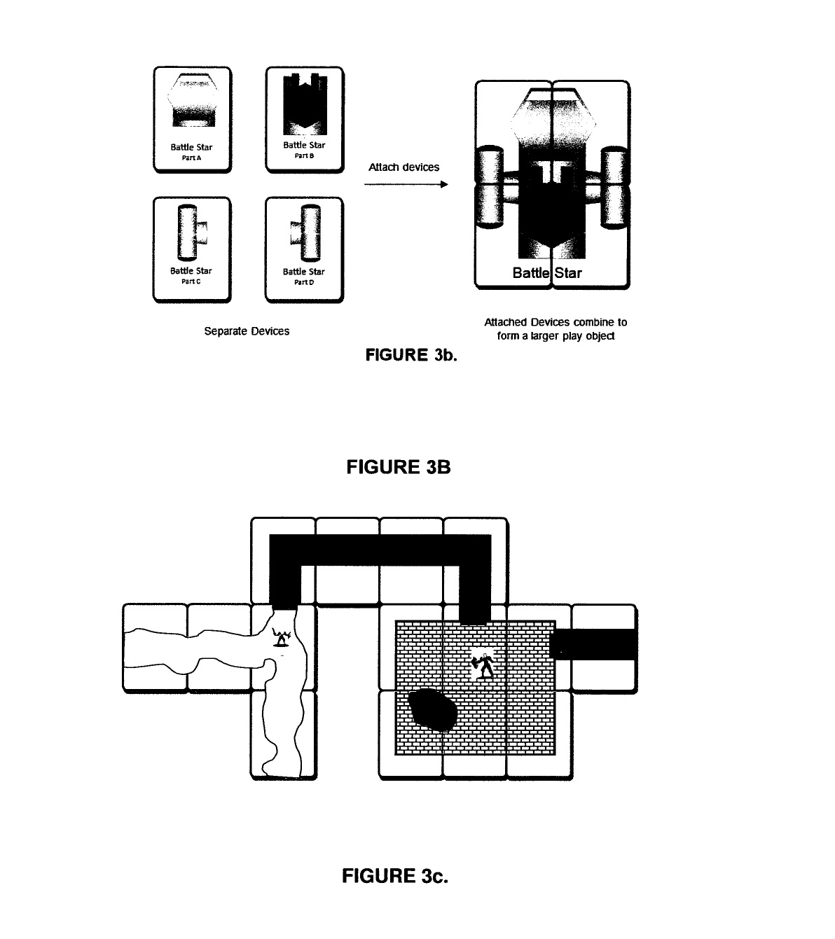

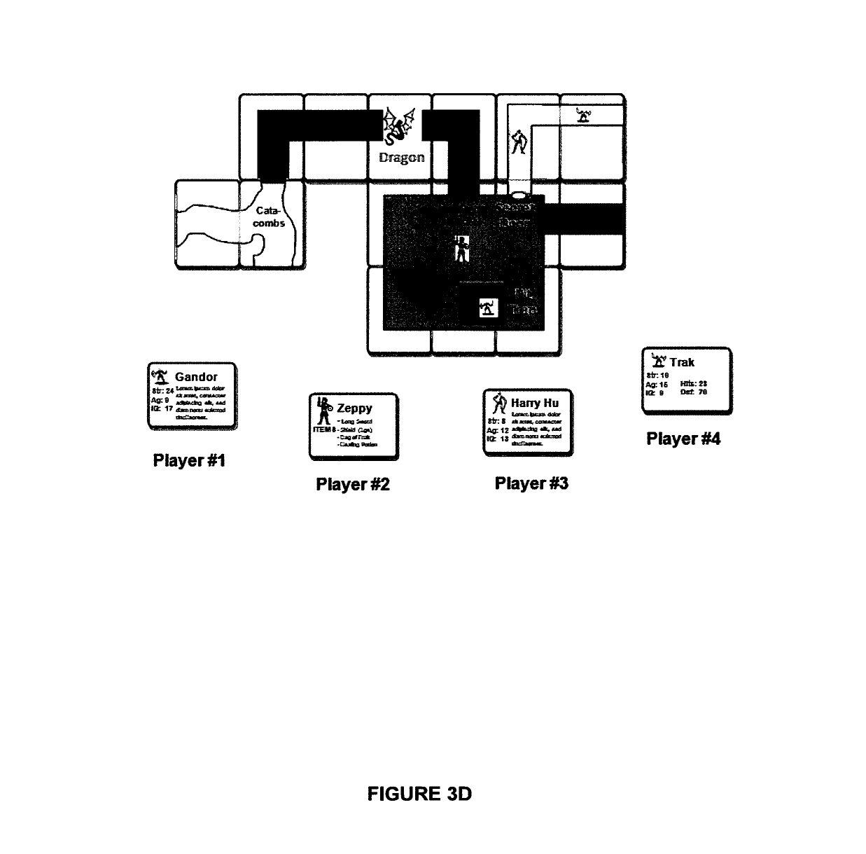

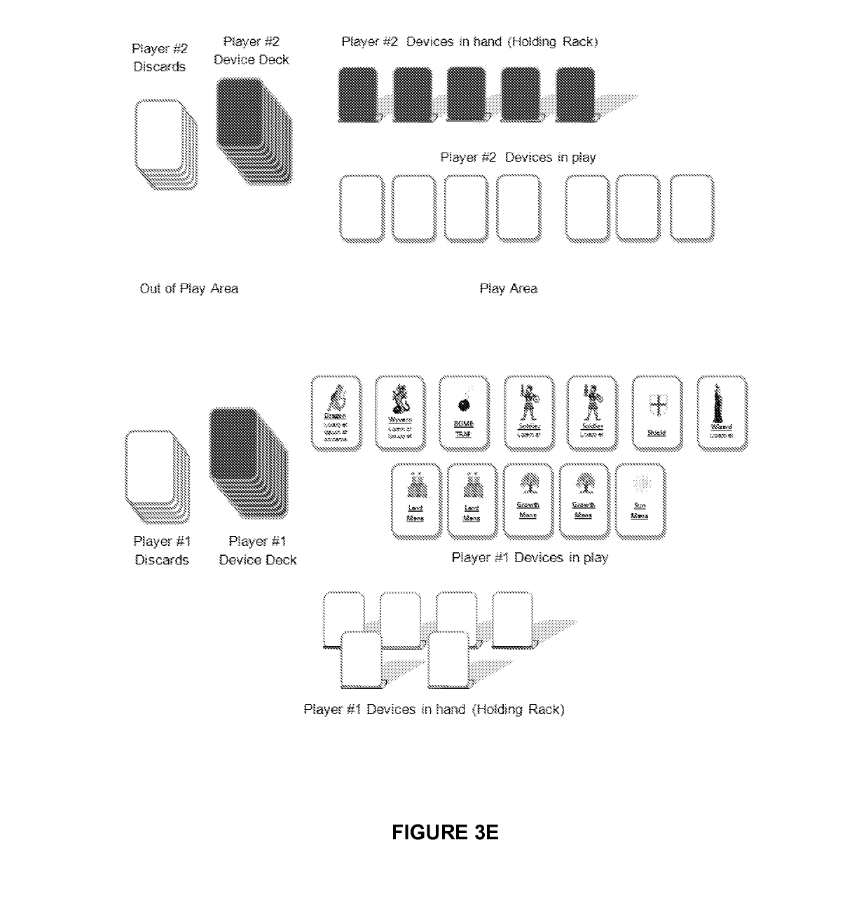

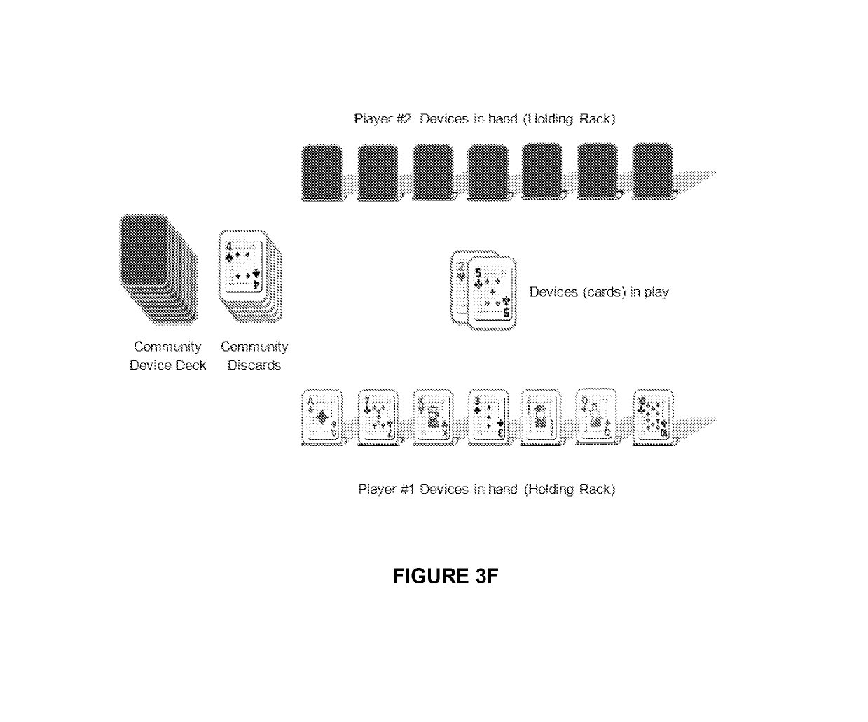

D.1. Referring to FIG. 3a, adjacent devices having their graphics images on their displays changing to an “enhanced” view. For example a single character on one device and a single character on another device might change when they are placed adjacent to one another, into a larger character on each display, and/or having their numeric characteristics improving (Eg. defence rating enhanced by +2).
D.2. Referring to FIG. 3b, adjacent devices may have their graphic images combined into a single image which crosses two or more displays, for example forming a squadron or team of characters, a larger spaceship, or any other combination of objects.
D.3. Game play actions affecting the display of graphic images of some or all of the other devices in the play area, for example a game may allow a player to trigger an explosion through any or all of the possible user inputs available in C1-C8 above. This trigger may result in an animated explosion which appears on some or all of the devices. This may also alter any numeric or other game play parameters associated with the devices in the particular game.
D.4. Animations across devices may include game play actions such as firing bullets or other projectiles, piloting ships and other vehicles, and so on.
D.5. Referring to FIG. 3c, devices may be used to plot terrain such as dungeons or buildings, with each device becoming a tile which when placed adjacent to another tile (device) forms an additional section of the terrain map. Players may remove parts of the terrain they have already visited, and re-attach devices to the new parts of terrain map they wish to move into. This in effect creates an infinitely large map which can be traversed by objects such as characters or vehicles. Different players may decide to use their devices to explorer different parts of the same game map by placing or moving their devices to open up different paths to the other players. Movement may be performed by touch screen sliding their pieces (characters, vehicles, etc.) across the terrain thus generated.

### E. Online/Internet

The gaming platform and system can connect directly to the internet through the Master Controller or the devices themselves. Some games will not require this and will remain stand-alone games, while other games may take advantage of an online internet connecting before, during and after game play. This opens up a range of additional game play options including, but not limited to, the following.

E.1. Massively Multiplayer Online Role Playing Games (MMORPG) are possible on this platform, with players using their sets of devices in the comfort of their own homes while playing against other players all over the world. Gaming companies would provide server farms to control the games just as they do with current PC or console-based MMORPGs such as “World Of Warcraft”, “Guild Wars” and “EVE Online”.
E.2. Non-MMORPG games could also be controlled in real-time or near real-time from game company servers through the Master Controller or directly to the devices themselves. This would allow a continually changing variety of new game play options while playing the game, limited only by the game developers' abilities.
E.3. Gaming companies who provide the gaming software for the platform could provide updates, upgrades, new modules, expansions, patches and the like over the internet. This could be performed in real time.

### F. Game Examples

### F.1. Trading Card Games

The gaming platform and preferred embodiment of the present invention provides an alternative and more convenient way for trading card game (TCG) players and collectable card game (CCG) players to store their cards and play their games. A single set of devices can be updated in real time with an unlimited number of pre-defined or customizable trading card decks by downloading from the game software. Updates to the game software may be provided on a regular basis by games manufacturers in a similar way to the release of new trading cards or collectable cards. A major advantage of the platform is that a player with a single set of devices may, in effect, carry their entire trading card collection and entire set of constructed decks. Some trading card games have in excess of 10,000 unique cards which in physical card form is not portable. Using devices from this gaming platform and the preferred embodiment allows all cards to be stored in the gaming platform memory, for recall to devices at any time.

Many TCGs also require players to form their own pre-constructed “decks” which comprise a library of, for example, 20 to 60 cards. With this deck they compete against opponent(s). Normally only a few constructed card decks are carried by players. However the gaming platform described here allows all of their constructed decks to be entered into the gaming software and recalled to all devices at once, so that their set of devices can be turned into any one of their decks at any time. In effect, they may store and recall any number of pre-constructed decks onto their devices. This is not possible using physical trading cards.

Playing a TCG is simply a matter of a player employing their devices to mimic playing regular trading cards. Typically this will involve utilising a Holding Rack to hold their ‘hand’ of devices (cards) as shown in FIG. 1c, playing them face up or face down onto the play area as shown in FIG. 1, and using touch screen controls or changing orientation of their devices depending on the normal rules for the TCG being played as shown in FIGS. 1a, 2a, 2b, 2c.

FIG. 3e shows an example of a trading card game which is currently in progress between two players. Typically, most trading card games require players to maintain and play with a deck or library of cards (Devices), a discard pile, a play area where they deploy their cards (Devices), and a hand (Holding Rack) in which they store their cards (Devices) before deploying them into the play area. The mechanics of play for any particular trading card game can be duplicated very simply using the Devices described herein. It also provides the possibility of future expansion of the rules, actions and options of currently existing trading card games by exploiting the additional play actions provided by the gaming platform.

### F.2. War Games

Devices are ideal to represent units or miniatures in traditional war games, and open up a range of additional functionality and game play options due to the interactive nature of the devices. Games based upon historical real wars, ancients, space battles, fantasy themes or any other conceivable war scenario may be played on this gaming platform. See for example FIGS. 3a and 3b.

### F.3. Role Playing Games (RPG)

Role Playing Games (RPG) like Dungeons & Dragons, Traveller, Star Wars RPG may easily be implemented on the gaming platform, not only as fully fledged stand-alone games, but also for use as game aids during traditional role playing. The game could either be wholly played out on the devices themselves, or alternatively the devices may be used as play aids, for example to map out and display terrain, e.g. dungeons as shown in FIG. 3c and provide ongoing game statistics.

FIG. 3d shows a state of the game at some point in time after the state shown in FIG. 3c. Here, it can be seen that player(s) have moved two Devices from the lower left of the setup shown in FIG. 3c and moved the two devices to the upper right of FIG. 3d, thus expanding and entering into new parts of the dungeon they are exploring. FIG. 3d also shows examples of possible play actions such as the discovery of a secret door and secret tunnel, a pit trap, and a dragon denizen appearing nearby, which they may soon encounter. It also shows each player utilising one of their devices as a Master Controller to display and control their character statistics, inventory and the like.

### F.4. Social Networking Games

The interaction of devices may introduce new social networking possibilities and/or games.

### F.5. New Games

Importantly, it is expected that the new game play options and new user inputs provided by this new gaming platform will allow games developers to design a plethora of new games unlike those played on boards, on traditional PCs or consoles.

### F.6. Classic Card Games

It would be understood that the invention can be used to play classic card games such as that shown in FIG. 3f. While a two player game is shown in the example it would be understood that any suitable number of players could play the game such as four players for bridge and 8 for poker games and the like. More or less players can also join is as may be suitable for the game. As can be seen in the Figure, each player has a set of cards in their hand held by a holding rack. There are cards in play as well as a community card deck and community discards. Other typical card games include snap, poker (any variation including Texas Hold-Em), bridge, rummy, blackjack, hearts, whist, spades, baccarat, solitaire, go fish, war, crazy 8s, slapjack, old maid, tarot, cribbage, pai gow, spoons, speed, pinochle and the like.

Any commercial processor may be used to implement the embodiments of the invention either as a single processor, serial or parallel set of processors in the system. Examples of commercial processors include, but are not limited to Merced™, Pentium™, Pentium II™, Xeon™, Celeron™, Pentium Pro™, Efficeon™, Athlon, AMD, Intel Centrino™, Intel Core Duo™, Intel Core 2 Duo™, Intel Centrino™, Intel Xeon™ and the like.

Display screens may be segment display screen, analogue display screens, digital display screens, CRTs, LED screens, Plasma screens, liquid crystal diode screens, and the like.

Although the invention has been described with reference to specific examples, it will be appreciated by those skilled in the art that the invention may be embodied in many other forms.

1. A portable electronic device including:
a memory for storing information including gaming information and location information;
a display for displaying at least a portion of the information stored on the memory;
a first data interface for communicating with a storage server and for transmitting gaming information to and receiving gaming information from the storage server;
a second data interface for communicating with at least one other adjacent portable electronic device and for transmitting location information to and receiving location information from the at least one other portable electronic device wherein the information displayed on the display is dependent at least in part on the location information.

2. A device according to claim 1 wherein there are a plurality of second data interfaces for communicating with a plurality of adjacent portable devices.

3. A device according to claim 2 wherein the portable device includes a user interface for allowing a user to control the device.

4-5. (canceled)

6. A device according to claim 1 wherein the storage server is remote to the portable electronic device.

7. (canceled)

8. A device according to claim 1 wherein the first data interface is a wireless communications interface.

9-10. (canceled)

11. A device according to claim 1 wherein the second data interface is a wireless communications interface.

12. A device according to claim 11 wherein the wireless communications interface is a proximity interface.

13-14. (canceled)

15. A device according to claim 1 further comprising a mechanical coupling or magnetic coupling system to mechanically or magnetically attach one or more portable electronic devices to one or more other portable electronic devices.

16-17. (canceled)

18. A device according to claim 15 wherein the portable electronic device includes a housing having four edges and wherein each edge includes a magnetic coupling system.

19-23. (canceled)

24. A device according to claim 1 wherein at least a portion of the gaming information is downloaded from the storage server to the plurality of devices at the commencement of each game.

25-27. (canceled)

28. A device according to claim 24 wherein the portable electronic device is allocated a character or object in the game and the gaming information displayed on each respective portable electronic device relates to the allocated character or object.

29. A device according to claim 28 wherein the game includes association information and at least a plurality of characters or objects in the game are associated such that when the association is activated when the portable electronic devices allocated to those associated characters or associated objects are placed adjacent one another.

30-31. (canceled)

32. A method of providing a portable electronic device including:
providing a memory for storing information including gaming information and location information;
providing a display for displaying at least a portion of the information stored on the memory;
providing a first data interface for communicating with a storage server and for transmitting gaming information to and receiving gaming information from the storage server;
providing a second data interface for communicating with at least one other adjacent portable electronic device and for transmitting location information to and receiving location information from the at least one other portable electronic device wherein the information displayed on the display is dependent at least in part on the location information.

33. A system for providing a game to a user including:
a storage server for storing information relating to the game; a plurality of portable electronic devices each having:
a first data interface for communicating with the storage server and receiving from the storage sever at least a portion of the information relating to the game;
a display for displaying the at least a portion of the information relating to the game;
a second data interface for communicating with at least one other adjacent portable electronic device and for transmitting location information to and receiving location information from the at least one other portable electronic device wherein the at least a portion of the information displayed on the display is dependent at least in part on the location information.

34. A system according to claim 33 wherein the game is provided to a plurality of players wherein at least a plurality of portable electronic device are allocated to each player of the game.

35. A system according to claim 34 wherein the storage server stores game rules and the game rules are transmitted to the plurality of portable devices.

36. A system according to claim 35 wherein the storage server is in constant communication with the plurality of portable electronic devices so as to control the rules of the game.

37. A system according to claim 36 wherein the portable electronic devices transmit the location information to the storage server so as to control the rules of the game.

38. A system according to claim 37 wherein the storage server transmits an activation signal to at least one portable electronic device in response to the location information.

39. A system according to claim 38 wherein the activation signal causes the at least one portable electronic device to display additional information on the display thereby activating a feature of the game.
